(19) United States
(12) Patent Application Publication
(10) Pub. No.: US 2012/0325937 A1
(43) Pub. Date: Dec. 27, 2012

(54) TWO-STAGE FUEL INJECTION VALVE FOR A DIESEL ENGINE, COMPRISING A SOLENOID VALVE AND A SHUTTLE VALVE

(75) Inventors: Deuk-Jin Park, Ulsan (KR); Eung-Sung Kim, Ulsan (KR); Ju-Tae Kim, Ulsan (KR); Jong-Suk Kim, Ulsan (KR); Kwang-Cheol Heo, Ulsan (KR); Kang-Yun Jung, Ulsan (KR); Eun Ha, Uiwang-Si (KR)

(73) Assignee: HYUNDAI HEAVY INDUSTRIES CO., LTD., Ulsan (KR)

(21) Appl. No.: 13/581,640

(22) PCT Filed: Mar. 4, 2011
(86) PCT No.: PCT/KR11/01489

§ 371 Date: Aug. 29, 2012

(30) Foreign Application Priority Data
Mar. 8, 2010 (KR) 10-2010-0020423

(51) Int. Cl. F02M 63/00

(52) U.S. Cl. 239/533.2

(57) ABSTRACT

Disclosed herein is a two-stage fuel injection valve for a diesel engine. The valve includes a fuel valve block (110) having therein a passage (1701) into which fuel is supplied; a nozzle (140) having a low pressure nozzle hole (160) and a high pressure nozzle hole (161); a needle valve (130) differentially opening the low pressure nozzle hole and the high pressure nozzle; pressure booster spindles (141), (142) and (143) pressurizing the needle valve to boost pressure of low-load fuel; a shuttle valve (150) configured to supply a gauge pressure to the pressure booster spindles, thus raising the pressure of the fuel; a lifting bush valve (180) discharging fuel to a fuel discharge hole through a gap between the fuel discharge hole and a nozzle holder when a solenoid valve (201) is moved upwards; and the solenoid valve (201) controlling pressure applied to the lifting bush valve.

### TECHNICAL FIELD

The present invention relates, in general, to two-stage fuel injection valves for diesel engines having solenoid valves and shuttle valves and, more particularly, to a fuel injection valve for a large or medium sized diesel engine which has a changed number of nozzle holes through which fuel is injected into a cylinder depending on the pressure of fuel discharged from a fuel pump, so that the valve can actively cope with low pressure and high pressure, and which can reduce a residual amount of fuel in an injection passage after injection, thus enhancing the combustion performance and fuel efficiency.

### BACKGROUND ART

Generally, conventional diesel engines include a single needle valve which is provided with a spring and configured such that if the pressure at which fuel is supplied is higher than an opening pressure, the valve is open and is otherwise closed. When high pressure fuel is supplied from the fuel pump into a fuel valve, if pressure higher than the opening pressure is formed in the fuel valve, the pressure of the fuel overcomes the force with which the spring pushes the needle valve so that the fuel lifts the needle valve and then is injected into the cylinder through several nozzle holes formed in the end of the nozzle.

In the conventional technique using the above-mentioned injection method, the fuel injection nozzle is operated by a basic injection mechanism in which all nozzle holes are open depending on a preset opening pressure. After the opening pressure has been reached, even if pressure higher than the opening pressure is applied into the fuel valve, the nozzle has no choice but to still inject fuel through the preset number of nozzle holes.

Therefore, if the engine is continuously operated at low speed or with a low load, fuel may not be injected. On the other hand, in conditions of a higher pressure than the opening pressure, all nozzle holes are used to inject fuel regardless of the magnitude of the pressure. Hence, the form that the fuel injection takes is not uniform depending on the pressure. In addition, the valve cannot actively control the amount of fuel injected so that it depends on the pressure.

Furthermore, because the several nozzle holes are open or closed at the same time, fuel that remains between the nozzle and the needle valve that has been closed after the injection has finished flows into the cylinder through the nozzle holes, thus causing a problem of the fumes being exhausted and a deterioration in fuel efficiency.

FIG. 8 illustrates a Wartsila-Sulzer type, a MAN-B&W type and a type for a medium engine as representative types of conventional fuel valves.

First, in the Wartsila-Sulzer type, when pressure is greater than the opening pressure but a higher pressure is no longer formed, fuel flows into the cylinder rather than being sprayed into the cylinder through several nozzle holes formed in a portion of a nozzle (in a portion designated by the arrow). Furthermore, even after fuel injection has finished, a space (SAC volume) between the closed needle valve and the nozzle holes is comparatively large. Thus, residual fuel that has been in this space flows into the cylinder, thus causing the above-mentioned problems.

The MAN-B&W type uses a sliding needle valve to reduce the SAC volume between the needle valve and the nozzle holes. This type, however, cannot actively cope with a pressure greater than the opening pressure, because the SAV volume between the needle valve and the nozzle holes is fixed.

In the type for medium engines, to improve upon the MAN-B&W type and the Wartsila-Sulzer type and to reduce the SAC volume, an injection hole is formed such that a needle is put as close to a combustion chamber as possible. Therefore, given that the needle is moved to open and close, the durability of the nozzle is reduced.

Furthermore, as shown in 8, a spring has high elastic force so that the valve can be open at a constant pressure. In addition, the conventional technique is configured such that a separate device other than the fuel valve artificially increases the fuel pressure and controls the opening pressure (that is, an additional pump is formed around the inlet of the fuel valve and increases the pressure of the fuel valve rather than having the fuel valve itself increase the pressure).

Moreover, in the conventional techniques of FIG. 8, the fuel valve itself cannot determine the injection timing, and fuel is injected according to the pressure of previously supplied fuel. That is, the injection timing and the maximum pressure of fuel are determined by the fuel pump or another medium before fuel enters the fuel valve.

### DISCLOSURE

### Technical Problem

Accordingly, the present invention has been made keeping in mind the above problems occurring in the prior art, and an object of the present invention is to provide a two-stage fuel injection valve for a diesel engine which is configured such that fuel supplied into a fuel valve is injected at a pressure greater than an opening pressure, and nozzle holes of a nozzle are differentially open at a pressure higher than the pressure of fuel supplied into the fuel valve and the opening pressure of an internal spring so that injection timing can be controlled in the valve itself, whereby even under conditions of a low speed or load operation, fuel can be injected at high pressure so that fuel can be more effectively vaporized, and under conditions of a high speed or load operation, low-pressure and high-pressure needle valves are open at the same time, and a large amount of fuel can be rapidly injected by a lot of nozzle holes, thus enhancing the combustion performance of the engine.

Another object of the present invention is to provide a two-stage fuel injection valve for a diesel engine in which the nozzle holes are differentially and sequentially open so that an SAC volume between the nozzle holes and the needle valve that is closed after fuel injection can be minimized, thus reducing fuel consumption and noxious gas (smoke, NOₓ).

### Technical Solution

In order to accomplish the above objects, the present invention provides a two-stage fuel injection valve for injecting fuel into a cylinder in a diesel engine, the two-stage fuel injection valve including: a fuel valve block having therein a passage into which fuel is supplied at a predetermined pressure through a fuel injection hole; a nozzle having a low pressure nozzle hole and a high pressure nozzle hole through which fuel supplied through the passage of the fuel valve block is injected; a needle valve installed in the nozzle, the needle valve sequentially and differentially opening the low pressure nozzle hole and the high pressure nozzle hole depending on a relative pressure difference; pressure booster spindles configured to have a multi-stage structure, the pressure booster spindles pressurizing the needle valve to boost pressure of low-load fuel to a high-pressure state, and needle springs providing elastic force to the pressure booster; a shuttle valve configured to supply a gauge pressure to the pressure booster spindles, thus raising the pressure of the fuel, the gauge pressure corresponding to a main pressure of fuel supplied to the needle valve; a lifting bush valve discharging fuel to a fuel discharge hole through a gap that is formed between the fuel discharge hole and a nozzle holder provided below the lifting bush valve when a solenoid valve disposed above the lifting bush valve is moved upwards; and the solenoid valve controlling pressure applied to an upper end of the lifting bush valve by a solenoid valve spring, thus controlling a fuel injection timing.

The lifting bush valve may be disposed above the nozzle holder that encases circumferences of the fuel valve block and the nozzle, and the lifting bush valve have a passage communicating with a passage formed in a fuel passage bush inserted into a central portion of a lower end thereof.

The needle valve may have a hole that forms a relative pressure difference depending on supply of fuel.

Before fuel reaches the pressure booster spindles, through the fuel injection port, the shuttle valve may apply fuel pressure and fuel standby pressure to the fuel injection port and apply pressure to the pressure booster spindles, and when pressure is relieved from a fuel discharge hole, the shuttle valve may overcome a pressure difference therebetween and provide interruption and flow.

The needle valve may be configured such that an opening pressure is increased, compared to a standby pressure, using the pressure booster spindles and the needle springs, wherein the solenoid valve spring that exerts force greater than the opening pressure supports the lifting bush valve, and an opening timing is controlled by the solenoid valve.

The needle valve may be configured such that because of a gauge pressure of the booster spindles that promote an increase in pressure, fuel reaches even a lower end of the nozzle through a hole formed in the needle valve and stands by, so that under conditions of low pressure, the needle valve creates pressure rather than being open, and the injection timing is controlled by the solenoid valve, whereby at an initial primary injection timing, low-load fuel can be injected at high pressure through the low pressure nozzle hole, and when the pressure increases, the needle valve moves upwards so that the high pressure nozzle hole is open.

Among the pressure booster spindles that have the multi-stage structure, the lowermost pressure booster spindle may be installed in a lower end of the fuel valve block and pressurizes the needle valve using the needle spring disposed in a hole formed in a lower end of the pressure booster spindle. The pressure booster spindle that is disposed at a medial position may be installed in a medial portion of the fuel valve block and pressurized by the pressure booster spindle that is provided above the pressure booster spindle. The pressure booster spindle that is disposed at an upper position may be divided into upper and lower parts by an annular protrusion provided on a circumferential surface thereof, wherein the needle spring is installed under the annular protrusion, and the needle spring is provided above the annular protrusion, whereby elastic force is applied to the pressure booster spindle upwards or downwards.

As described above, in the present invention, a fuel injection device increases the pressure of the supplied fuel using an internal device so that the injection pressure can be increased. In other words, even under conditions of a low load, fuel can be injected at high pressure. A solenoid valve adjusts the injection timing depending on the pressure.

Furthermore, two-stage nozzle holes of low pressure and high pressure are differentially open so that depending on the pressure difference, a cross-sectional area of fuel discharge can be reduced, thus making the form of fuel injection uniform. Under conditions of a maximum pressure, a large amount of fuel can be rapidly injected at the same time. Therefore, the present invention ensures superior combustion performance under conditions not only of low pressure but also of high pressure.

In addition, a passage in the nozzle is generally narrow, and depending on the pressure, the nozzle holes are differentially and sequentially open. Therefore, an SAC volume between the nozzle holes and the needle valve that is closed after fuel injection can be minimized. Thereby, the amount of residual fuel that remains behind after the injection and then flows into a combustion cylinder can be reduced, thus decreasing noxious gas (smoke, NOₓ), and enhancing fuel efficiency.

### DESCRIPTION OF DRAWINGS

FIG. 1 is a sectional view illustrating an embodiment of the present invention;

FIG. 2 is a sectional view illustrating an embodiment of the operation of an injection valve before the valve is opened by fuel, that is, the fuel pressure operates a solenoid valve according to the present invention;

FIG. 3 is a sectional view illustrating an embodiment of the operation of the injection valve during fuel opening timing, that is, after the fuel pressure has operated the solenoid valve according to the present invention;

FIG. 4 is a view showing the operation of the solenoid valve in which fuel is injected by a primary pressure, according to the present invention;

FIG. 5 is a view showing the operation of the solenoid valve in which the primary fuel and secondary fuel are injected at the same time under conditions of high speed and a load which create high pressure, according to the present invention;

FIG. 6 is a graph showing the variation in pressure when a conventional fuel valve is under low load conditions;

FIG. 7 is a graph showing variations in pressure while fuel is primarily and secondarily injected at high pressure under conditions of low load according to the present invention; and

FIG. 8 is of schematic views showing conventional fuel injection valves.

### DESCRIPTION OF THE REFERENCE NUMERALS IN THE DRAWINGS

(100): nozzle holder
(110): fuel valve block
(130): needle valve
(131): solenoid valve spring
(132, 133, 134, 135): needle spring
(140): nozzle
(141, 142, 143): pressure booster spindle
(150): shuttle valve
(160): low pressure nozzle hole
(161): high pressure nozzle hole
(170): fuel injection hole
(171): fuel discharge hole
(180): lifting bush valve
(181): fuel passage bush
(200): Governor cable
(201): solenoid valve
(1301): hole
(1501, 1701, 1801): passage
(1411): protrusion

### BEST MODE

Hereinafter, the construction and operation of a preferred embodiment of the present invention will be described with reference to the attached drawings. If in the specification, detailed descriptions of well-known functions or configurations would unnecessarily obfuscate the gist of the present invention, the detailed descriptions will be omitted.

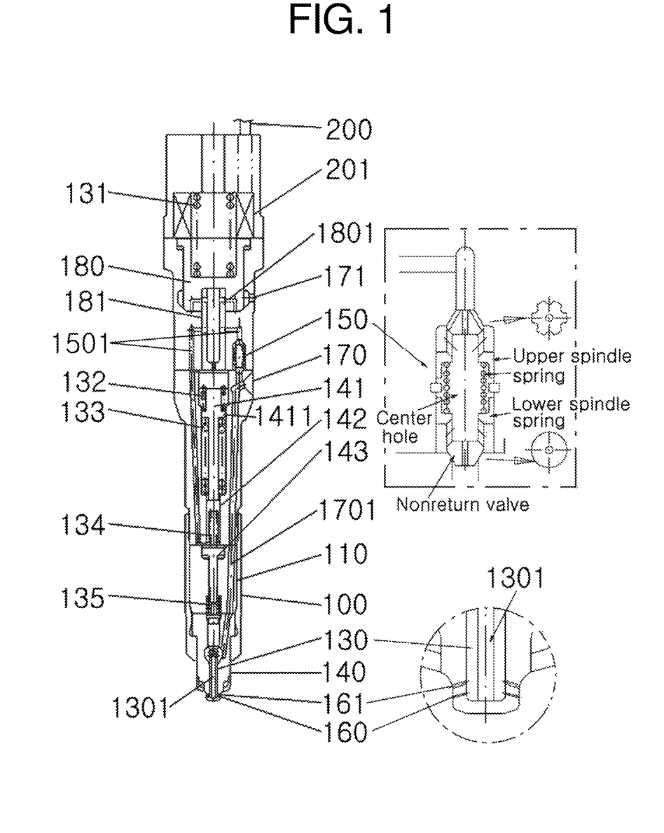

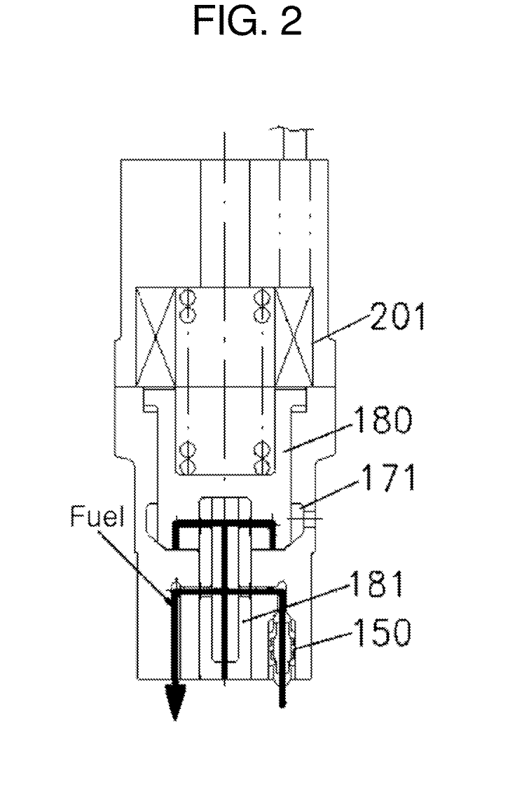

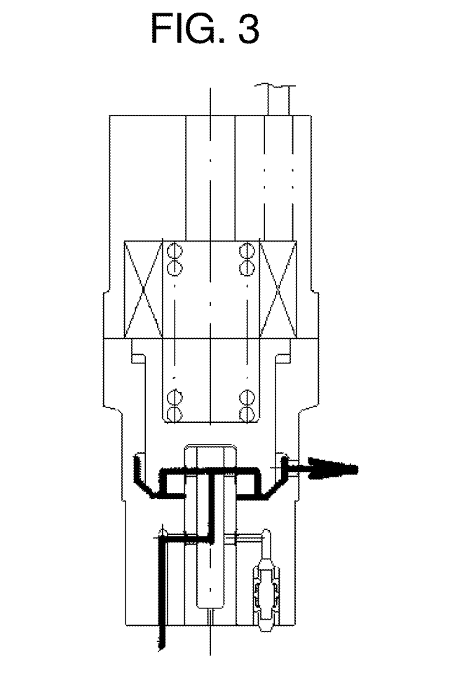

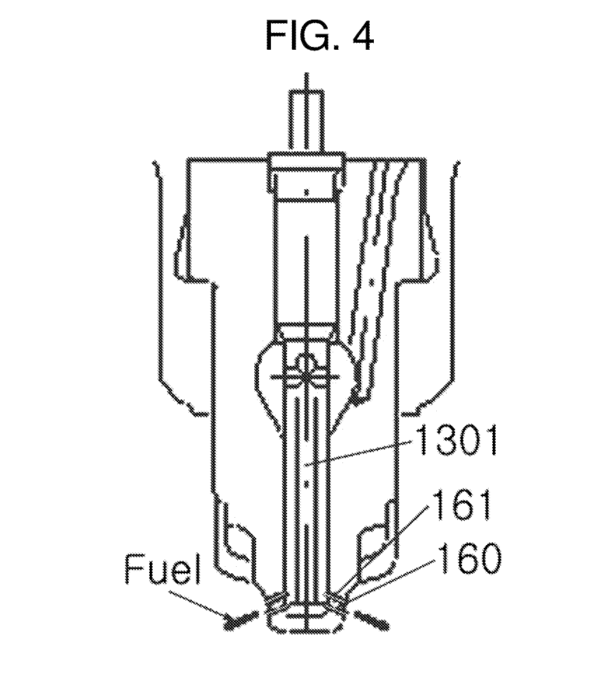

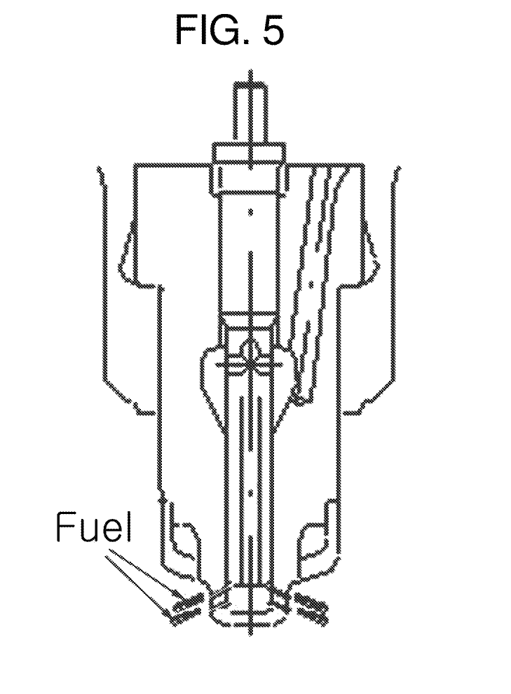

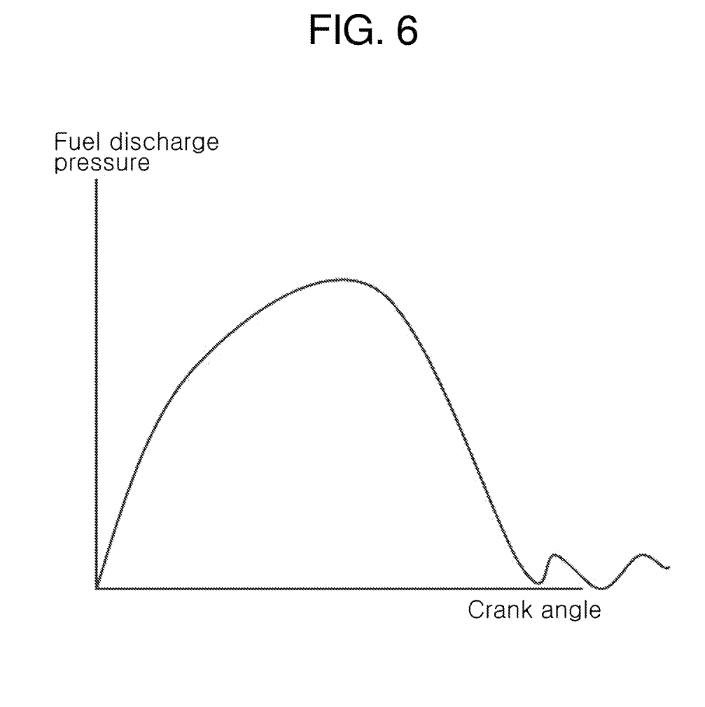

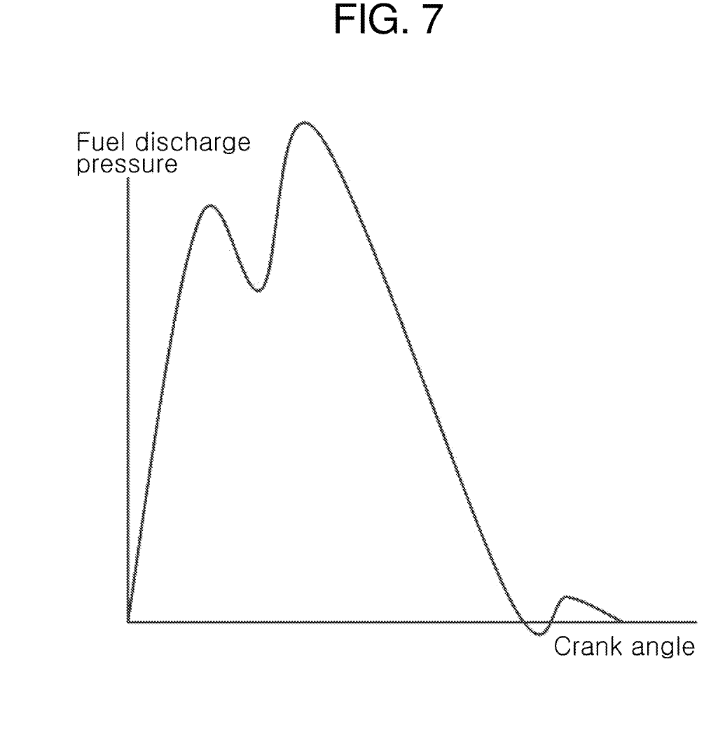

FIG. 1 is a sectional view illustrating an embodiment of the present invention. FIG. 2 is a sectional view illustrating an embodiment of the operation of an injection valve in which the pressure is applied to a pressure booster before a solenoid is operated such that fuel is not injected at low load and pressure. FIG. 3 is a sectional view illustrating the operation of the injection valve in which the solenoid is operated so that a gauge pressure that has been standing by in the pressure booster is discharged. FIG. 4 is a view showing an embodiment of primary fuel injection. FIG. 5 is a view showing an embodiment of secondary fuel injection which is conducted under conditions of high speed and load. FIG. 6 is a graph showing the variation in pressure when a conventional fuel valve is under conditions of low load. FIG. 7 is a graph showing variations in pressure while fuel is primarily and secondarily injected at high pressure under low load conditions according to the present invention.

Below the term ‘low pressure’ refers to an opening pressure at which fuel injection must begin, and the term ‘high pressure’ refers to a pressure which is set by a spring so that when a pressure beyond the opening pressure is reached in a fuel valve, a nozzle hole can be secondarily opened. That is, with regard to low pressure and high pressure, low pressure refers to the opening pressure while high pressure refers to the relative pressure.

First, the construction of a two-stage fuel injection valve for a diesel engine having a solenoid valve and a shuttle valve according to a preferred embodiment of the present invention will be described in detail with reference to FIG. 1.

The present invention is configured such that the pressure which fuel enters a fuel valve is increased by gauge pressure formed by a booster spindle so that fuel can be injected at high pressure even under low load conditions, and fuel injection nozzle holes open differently depending on the pressure. To embody this construction, the present invention includes a fuel valve block 110 which has a passage 1701 into which fuel is supplied at a predetermined pressure through a fuel injection hole 170 connected to a high pressure pipe (not shown) that transfers fuel from an external fuel pump (not shown);

a nozzle 140 which is coupled to a lower end of the fuel valve block and has a low pressure nozzle hole 160 through which fuel is injected into a cylinder (not shown) at low speed and under a low load, and a high pressure nozzle hole 161 through which fuel is injected into the cylinder at high speed and under a high load;

a nozzle holder 100 which encloses the circumferences of the fuel valve block and the nozzle;

a needle valve 130 which is installed in the nozzle and has a hole 1301 that forms a pressure difference depending on supply of fuel so that the needle valve 130 sequentially and differentially opens the low pressure nozzle hole and the high pressure nozzle hole depending on the pressure of fuel;

pressure booster spindles 141, 142 and 143 which form a multi-stage structure and pressurize the needle valve downwards to boost the pressure of low-load fuel to a high-pressure state, and needle springs 132, 133, 134 and 135 which provide elastic force to the pressure booster spindles 141, 142 and 143 which have clearances of predetermined intervals;

a shuttle valve 150 which is installed in an inlet of a fuel injection port and supplies a gauge pressure corresponding to a main pressure of supplied fuel through a passage 1501 connected to the pressure booster spindles, thus increasing the pressure of the fuel;

a lifting bush valve 180 which is disposed above the nozzle holder and has in a lower end thereof a hollow space into which a part of a fuel passage bush 181 that is disposed in a hollow space of the nozzle holder is inserted, so that the lifting bush valve 180 communicates with a passage 1801 defined in the fuel passage bush 181, wherein the lifting bush valve 180 is configured such that fuel is drawn thereinto through a space, which is formed between it and the nozzle holder when a solenoid valve 201 disposed above the lifting bush valve 180 moves upwards, and then is discharged through a fuel discharge hole; and

the solenoid valve 201 which controls pressure applied to the upper end of the lifting bush valve by a solenoid valve spring 131, thus controlling a fuel injection timing depending on engine control.

The reason why the hole 1301 that is formed in the nozzle creates a relative pressure difference depending on supply of fuel is that pressures applied to the needle valve 130 are a gauge pressure (pushing force) and pressures at which the needle springs push it, and when the pressure of fuel supplied into the passage 1701 is greater than the pressure which is generated between the inner surface of the hole 1301 and the needle valve, the needle valve 130 is open. This refers to a relative pressure difference.

Among the pressure booster spindles 141, 142 and 143 that have the multi-stage structure and pressurize the needle valve downwards, the lowermost pressure booster spindle 143 is installed in the lower end of the fuel valve block 110 and pressurizes the needle valve 130 using the needle spring 134 which is disposed in a hole formed in the lower end of the pressure booster spindle 142.

Furthermore, the pressure booster spindle 142 that is disposed at a medial position among the spindles is installed in a medial portion of the fuel valve block 110 and is pressurized by the pressure booster spindle 141 that is provided above it.

The pressure booster spindle 141 that is disposed at an upper position among them is divided into upper and lower parts by an annular protrusion 1411 provided on a circumferential surface thereof. The needle spring 133 is installed under the annular protrusion, and the needle spring 132 is provided above the annular protrusion, whereby elastic force can be applied to the pressure booster spindle 141 upwards or downwards.

Further, if fuel which is supplied through the shuttle valve is continuously supplied through the passage 1501, pressure is applied to the upper end of the lowermost pressure booster spindle 143 so that the pressure booster spindle 143 is moved downwards, thus further pressurizing the needle valve 130. Thereby, additional gauge pressure is provided to the needle spring 135 that is providing gauge pressure to the main pressure of the fuel supplied through the passage 1701, thus increasing the pressure of the fuel so that it opens the needle valve.

That is, because the shuttle valve 150 is provided, before fuel reaches the pressure booster spindles 141, 142 and 143 after passing through the fuel injection port 170, the shuttle valve 150 applies fuel pressure and fuel standby pressure to the fuel injection port 170 and applies pressure to the pressure booster spindle. When pressure is relieved from the fuel discharge hole 171, it overcomes a pressure difference of fuel standby pressure and interrupts or allows the flow of fuel to be injected and drained fuel.

The operation of the shuttle valve used in the present invention will be explained in detail.

The shuttle valve is basically operated in such a way that while the lower end of the shuttle valve is automatically open like a nonreturn valve and the upper spindle is not completely open because of an area difference, the pressure of fuel drawn from the fuel injection port 170 is supplied through a center hole and a hole of a contact surface. When pressure past the shuttle valve is high, before it is opened by the force of a spring of the shuttle valve, the pressure is primarily reduced by the center hole and contact hole. If it is over pressure, the spindle is open. Here, although the shuttle valve is a nonreturn valve which is configured such that the lower spindle to which reverse pressure is applied is not open, it is a valve which reduces the entire pulsation using an orifice function which finely reduces the pressure using the center hole.

Furthermore, the needle valve 130 is configured such that the opening pressure is increased, compared to standby pressure, using the pressure booster spindles 141, 142 and 143 and the needle springs 132, 133, 134 and 135. Here, the solenoid valve spring 131 that exerts force greater than the opening pressure supports the lifting bush valve 180. The opening timing is controlled by the solenoid valve 201.

In the needle valve 130 installed in the nozzle 140, fuel supplied thereinto reaches even the lower end of the nozzle 140 through a fuel hole formed in the needle valve 130 and stands by so that under conditions of low pressure, it merely creates pressure rather than opening the valve. This is due to gauge pressure of the booster spindles 141, 142 and 143 that promote an increase in pressure. This gauge pressure makes it possible to adjust the pressure of the supplied fuel to the desired high pressure.

Further, at an initial injection timing, fuel of even a low load can be injected at high pressure. Here, the injection timing is controlled by the solenoid valve 2010.

At a primary injection timing, fuel is injected through the low pressure nozzle hole 160 that is comparatively small, and at a timing that the pressure increases, the needle valve 130 moves upwards so that the high pressure nozzle hole 161 is open.

In the drawings, reference numeral 200 denotes a governor cable.

Hereinafter, the operation of the present invention having the above-mentioned construction will be explained in detail.

Fuel pressure supplied from the fuel injection port 170 stands by even in the needle valve 130. Simultaneously, fuel supplied from the shuttle valve 150 has an affect on the pressure booster spindles 141 and 143 and serves as a standby pressure so that the needle valve 130 stands by at a pressure greater than the fuel pressure supplied from a main inlet (refer to FIG. 2).

When the required degree of pressure has been reached, the solenoid valve 201 is operated so that gauge pressure applied to the pressure booster spindles 141, 142 and 143 is discharged to the fuel discharge hole 171 through a space formed by upward movement of the lifting bush valve 180. Thereby, the needle valve 130 is operated so that the low pressure nozzle hole 160 is primarily open. When the engine reaches a high load and a high pressure, fuel is injected through the nozzle that has the high pressure nozzle hole 161 (refer to FIGS. 3 through 5).

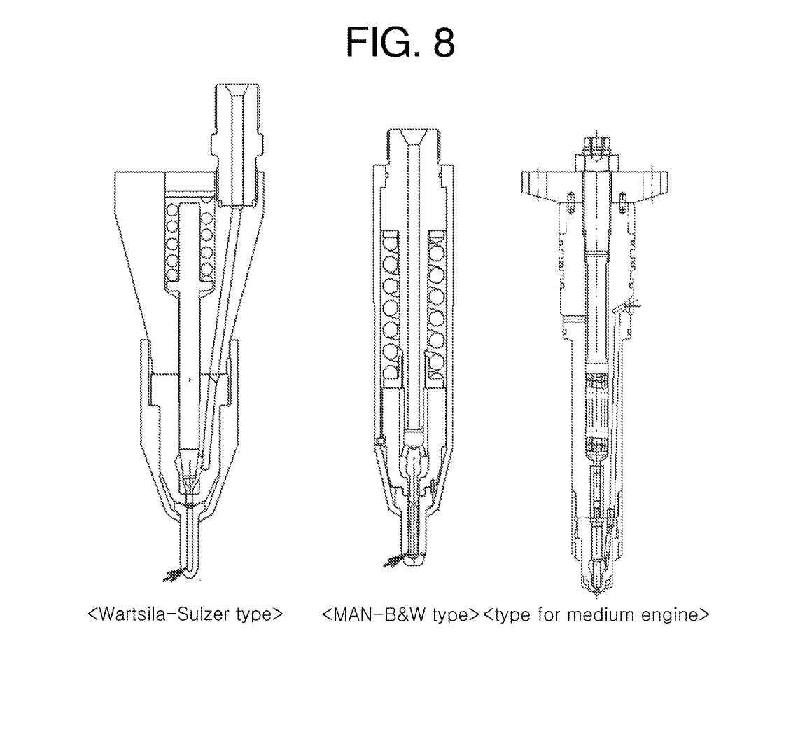

Furthermore, the reason that fuel is not supplied to the shuttle valve in FIG. 8 is because when the lifting bush valve 180 is open, the vicinity of the fuel discharge hole 171 is less than the standby pressure (typically, 5 Bar or less), and the standby pressure of the vicinity of the shuttle valve ranges from 100 Bar to 1000 Bar.

As shown in FIGS. 1 and 2, before fuel injection begins, the passage in the fuel valve is filled with fuel supplied thereinto through the fuel injection port 170 from a fuel pump (not shown) via a high pressure pipe, but the pressure of the fuel cannot overcome the elastic force of the needle springs 131, 132, 133, 134 and 135 and the force of the pressure booster spindles 141, 142 and 143 so that the needle valve does not lift. Thus, the fuel merely increases in pressure and stands by without being discharged to a cylinder (not shown) through the high or low pressure nozzle hole.

As shown in FIGS. 3 through 5, at a fuel injection timing, the lifting bush valve 18 is pressurized by the solenoid valve spring 131 and thus moved upwards in response to the preset opening pressure of the solenoid valve 201 and the injection timing. Also, gauge pressure is supplied to the lowermost pressure booster spindle 143 by fuel that is continuously supplied by the shuttle valve. Then, the pressurizing force of the lowermost pressure booster spindle 143, which was created by the above gauge pressure, is removed. The main pressure of fuel is greater than the elastic force of the needle spring 135, thus moving the needle valve upwards so that fuel supplied through the hole 1301 of the needle valve begins to be injected through the low pressure nozzle hole 160 and, simultaneously, is injected through the high pressure nozzle hole 161 by the pressure of the fuel.

Furthermore, at the end of fuel injection, the pressure in the fuel valve is reduced. When the pressure in the fuel valve is reduced to below a pressure that can sequentially or simultaneously overcome the elastic forces of the needle springs 131, 132, 133, 134 and 135, the needle valve 130 is pushed downwards by the needle springs 131, 132, 133, 134 and 135 so that the low and high pressure nozzle holes 160 and 161 are closed, thus completing a cycle of fuel injection.

FIG. 6 is a graph of the pressure of fuel injection according to the conventional technique. FIG. 7 is a graph illustrating the characteristics of the present invention in that even at an initial stage, low-load fuel is injected at high pressure in the two-stage injection manner. In the graphs, the X-axis (horizontal direction) refers to a crank angle, and the Y-axis (vertical direction) refers to a fuel discharge pressure.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A two-stage fuel injection valve for injecting fuel into a cylinder in a diesel engine, the two-stage fuel injection valve comprising:
a fuel valve block (110) having therein a passage (1701) into which fuel is supplied at a predetermined pressure through a fuel injection hole (170);
a nozzle (140) having a low pressure nozzle hole (160) and a high pressure nozzle hole (161) through which fuel supplied through the passage (1701) of the fuel valve block is injected;
a needle valve (130) installed in the nozzle, the needle valve (130) sequentially and differentially opening the low pressure nozzle hole and the high pressure nozzle hole depending on a relative pressure difference;
pressure booster spindles (141), (142) and (143) configured to have a multi-stage structure, the pressure booster spindles (141), (142) and (143) pressurizing the needle valve to boost pressure of low-load fuel to a high-pressure state, and needle springs (132), (133), (134) and (135) providing elastic force to the pressure booster spindles (141), (142) and (143);
a shuttle valve (150) configured to supply a gauge pressure to the pressure booster spindles, thus raising the pressure of the fuel, the gauge pressure corresponding to a main pressure of fuel supplied to the needle valve;
a lifting bush valve (180) discharging fuel to a fuel discharge hole through a gap that is formed between the fuel discharge hole and a nozzle holder provided below the lifting bush valve when a solenoid valve (201) disposed above the lifting bush valve is moved upwards; and
the solenoid valve (201) controlling pressure applied to an upper end of the lifting bush valve by a solenoid valve spring (131), thus controlling a fuel injection timing.

2. The two-stage fuel injection valve according to claim 1, wherein the lifting bush valve (180) is disposed above the nozzle holder that encases circumferences of the fuel valve block and the nozzle, and the lifting bush valve (180) has a passage (1801) communicating with a passage formed in a fuel passage bush (181) inserted into a central portion of a lower end thereof.

3. The two-stage fuel injection valve according to claim 1, wherein the needle valve (130) has a hole (1301) that forms a relative pressure difference depending on supply of fuel.

4. The two-stage fuel injection valve according to claim 1, wherein before fuel reaches the pressure booster spindles (141), (142) and (143) through the fuel injection port (170), the shuttle valve (150) applies fuel pressure and fuel standby pressure to the fuel injection port (170) and applies pressure to the pressure booster spindles, and when pressure is relieved from a fuel discharge hole (171), the shuttle valve overcomes a pressure difference of fuel standby pressure and interrupts or allows the flow of fuel to be injected and drained fuel.

5. The two-stage fuel injection valve according to claim 1, wherein the needle valve (130) is configured such that an opening pressure is increased, compared to a standby pressure, using the pressure booster spindles (141), (142) and (143) and the needle springs (132), (133), (134) and (135), wherein the solenoid valve spring (131) that exerts force greater than the opening pressure supports the lifting bush valve (180), and an opening timing is controlled by the solenoid valve (201).

6. The two-stage fuel injection valve according to claim 1, wherein the needle valve (130) is configured such that because of a gauge pressure of the booster spindles (141), (142) and (143) that promote an increase in pressure, fuel reaches even a lower end of the nozzle (140) through a hole (1301) formed in the needle valve (130) and stands by, so that under conditions of low pressure, the needle valve creates pressure rather than being open, and the injection timing is controlled by the solenoid valve (2010), whereby at an initial primary injection timing, low-load fuel can be injected at high pressure through the low pressure nozzle hole (160), and when the pressure increases, the needle valve (130) moves upwards so that the high pressure nozzle hole (161) is open.

7. The two-stage fuel injection valve according to claim 1, wherein among the pressure booster spindles (141), (142) and (143) that have the multi-stage structure, the lowermost pressure booster spindle (143) is installed in a lower end of the fuel valve block (110) and pressurizes the needle valve (130) using the needle spring (134) disposed in a hole formed in a lower end of the pressure booster spindle (142),
the pressure booster spindle (142) that is disposed at a medial position is installed in a medial portion of the fuel valve block (110) and is pressurized by the pressure booster spindle (141) that is provided above the pressure booster spindle (142), and
the pressure booster spindle (141) that is disposed at an upper position is divided into upper and lower parts by an annular protrusion (1411) provided on a circumferential surface thereof, wherein the needle spring (133) is installed under the annular protrusion, and the needle spring (132) is provided above the annular protrusion, whereby elastic force is applied to the pressure booster spindle (141) upwards or downwards.
